(19) United States
(12) Patent Application Publication
(10) Pub. No.: US 2014/0076824 A1
(43) Pub. Date: Mar. 20, 2014

(54) ARRANGEMENT FOR GENERATION AND TREATMENT OF WATER, METHOD FOR GENERATION AND TREATMENT OF WATER AND AIRCRAFT WITH SUCH AN ARRANGEMENT

(71) Applicant: AIRBUS OPERATIONS GMBH, HAMBURG (DE)

(72) Inventors: Thorsten Otto, Hamburg (DE); Elisabeth Wobst, Hamburg (DE); Boris Barylo, Hamburg (DE)

(21) Appl. No.: 14/084,927

(22) Filed: Nov. 20, 2013

Related U.S. Application Data
(63) Continuation of application No. PCT/EP2012/058635, filed on May 10, 2012.
(60) Provisional application No. 61/488,632, filed on May 20, 2011.

(30) Foreign Application Priority Data
May 20, 2011 (DE) 10 2011 102 177.2

(51) Int. Cl. C02F 1/68; C02F 1/66

(52) U.S. Cl. CPC C02F 1/685; C02F 1/66
USPC 210/739; 210/96.1

(57) ABSTRACT

An arrangement for generating and treating water is provided. The arrangement includes a fuel cell with a water-generating system, a salination unit for the salination of water, a state measuring device for acquiring an operating state of the salination unit, a water-receiving reservoir for receiving water, a water-quality measuring device for measuring the water quality of the water whose salt content has been increased, and a control unit. The salination unit is designed to add a basic salt to water so that apart from the salt content, an excessively acidic pH-value of the dispensed water is increased and stabilized. To this effect the control unit is connected to the water-quality measuring device and to the state measuring device and is designed, for setting a predetermined water quality, to control the salination unit depending on the operating state of the salination unit and on the measured water quality.

### CROSS-REFERENCE TO RELATED APPLICATIONS

This is a continuation of International Application No. PCT/EP2012/058635, filed May 10, 2012, which application claims priority to German Patent Application No. 10 2011 102 177.2, filed May 20, 2011, and to U. S. Provisional Patent Application No. 61/488,632, filed May 20, 2011, which are each incorporated herein by reference in their entirety.

### TECHNICAL FIELD

This application pertains to an arrangement for generating and treating water, to a method for generating and treating water, and to an aircraft comprising such an arrangement in an aircraft.

### BACKGROUND

Generally, arrangements for generating water on board means of transport are known, and may be based on generating water by means of exhaust gas of a fuel cell system. In this example, moist exhaust gas of a fuel cell is cooled in a condenser and is subsequently separated from the exhaust gas by means of a water separator.

Furthermore, it is known to treat water that has been obtained in such a process, because of the very small content of ions, by salination in order to increase the salinity or the tonicity so that it is suitable for human consumption. This is, for example, disclosed in DE 10 142 215 A1.

In addition, other objects, desirable features and characteristics will become apparent from the subsequent summary and detailed description, and the appended claims, taken in conjunction with the accompanying drawings and this background.

### SUMMARY

The water condensed from a fuel cell exhaust gas comprises a very low ion content and practically no buffering capacity, and consequently the pH-value of the condensate resulting from a solution, in particular from CO₂ from the ambient air, is in an acid range of approximately 5.5 or less, which is below the lower limit of the German Drinking Water Ordinance. While it is possible to increase the salinity of the condensate by means of salination of the condensate with a neutral salt, this would not have any influence on the excessively low pH-value and on the buffering capacity.

Accordingly, the various teachings of the present disclosure provides an arrangement and a method for generating and treating water, in which arrangement and method a drinking water quality is achieved that provides adequate salinity, a buffering capacity and a pH-value that is within the value range specified by commonly-used drinking water regulations.

An arrangement according to the various teachings of the present disclosure for generating and treating water comprises a fuel cell with a water-generating system, a salination unit for the salination of water with a variable salt concentration, a state measuring device for acquiring an operating state of the salination unit, a water-receiving reservoir for receiving water, a water-quality measuring device for measuring the water quality of the water whose salt content has been increased, and a control unit. The salination unit is designed to add a basic salt with an alkaline effect to water. The water-receiving reservoir is arranged downstream of the salination unit for receiving water whose salt content has been increased, and is connected to the water-quality measuring device. The water-quality measuring device is arranged downstream of the salination unit. The control unit is connected to the water-quality measuring device and to the state measuring device and is designed, for setting a predetermined water quality in the water-comprising reservoir, to control the salination unit depending on the operating state of the salination unit and on the measured water quality.

As mentioned above, a fuel cell is in a position, by means of oxidation of hydrogen, to generate an exhaust gas comprising water vapor, from which exhaust gas water can be condensed and removed. The condensate obtained in the water-generating system comprises a pH-value of 5.5 or less. The salination unit as a core of the present disclosure is designed with a basic salt or salt mixture that is suitable to increase the pH-value of the condensate. Admixing basic salt to the condensate thus at the same time increases the salinity, the buffering capacity and the pH-value of the water obtained. In this context the term “buffering capacity” relates to the ability of a solution to change the pH-value to a significantly lesser extent when acid or a chemical base is added than would be the case in a non-buffered system. Generally, the salt or the salt mixture is balanced in such a manner that at the same time an optimal increase in the salinity and an optimal adjustment of the pH-value can take place. Sodium hydrogen carbonate is one example of such a salt.

Among other things a geometrically determinable residual size of a salt body through which or against which a liquid can flow, the presently existing salt reserve in the salination unit or the available quantity of a saline solution may be considered to be an operating state of the salination unit. In this arrangement the operating state is generally to represent a characteristic variable relating to the operating characteristics of the salination unit, which variable characterizes the salination behavior of the salination unit. In addition, it is an elementary requirement for the control unit to know which physical parameters are to be changed as controlled variables when regulating or controlling the salination unit in order to achieve the desired salination of a condensate fed to the salination unit. These parameters may, for example, comprise the volume flow of water that flows through the salination unit. In order to control the salination unit taking into account this parameter for example, conveying equipment with an adjustable volume flow may be used, as may a valve that regulates the volume flow, or other means with which a predetermined volume flow through the salination unit results.

With the use of the control unit, which is connected both to the water-quality measuring device and to the state measuring device, a desired drinking water quality in the water-receiving reservoir can be automatically set. The present disclosure thus describes an arrangement for generating and treating water, by means of which arrangement salt can be added to the de-ionized water obtained from a fuel cell so that the limits relating to the pH-value and the conductivity according to the drinking water ordinance are automatically complied with, taking into account a variable water production of the fuel cell, and a changeable salt delivery of a salination unit. Ideally, salt is added only to such an extent that the degree of hardness of the water is low. This minimizes calcification of the devices and pipes.

In one exemplary embodiment the salination unit comprises conveying equipment that is arranged downstream of the fuel cell, which conveying equipment is designed to lead water from the fuel cell or its water generating system to the salination unit. Generally-speaking the conveying equipment is designed to pressurize condensate from the water generating system to a certain extent so that transport of the condensate to a salination device that dispenses salt ions is carried out. In this arrangement the conveying equipment can be implemented in various ways. Apart from impeller pumps or piston pumps it is also possible to provide intermittent operation of a valve for feeding compressed air to an intermediate reservoir of the water-generating system for the compressed-air driven conveyance of condensate. As explained above, it would be preferable for the volume flow caused by the conveying equipment to be adjustable.

In one exemplary embodiment of the present disclosure, the water-quality measuring device is a device for measuring the conductivity of water. The condensate obtained from the fuel cell exhaust gas comprises very few ions, and thus very low salinity and low conductivity. Apart from increasing salinity, salination also has a favorable effect on the pH-value so that the conductivity of the water can be used as a measured variable both relating to salinity and to the pH-value. By measuring the conductivity of the water whose salt content has been increased, due to the use of an basic salt or a salt mixture and a, for example experimentally determined, usual pH-value of the condensate from the water generating device, from the conductivity of the water it is possible to directly deduce the set pH-value of the water whose salt content has been increased. This obviates the need for complex pH-value measuring, which for example with the use of the arrangement according to the present disclosure in a means of transport, because of the temperatures, vibrations and movement forces occurring therein, would hardly be feasible with the use of conventional methods.

In one of various embodiments of the present disclosure the salination unit comprises at least one salt body enclosed by a housing, wherein the housing comprises an inlet and an outlet so that, due to the flow around or flow through, salt ions are dispensed to water flowing in through the inlet and flowing out through the outlet. Such a salination unit carries out a continuous salination process in which salt ions can be continuously dispensed to water that flows through. The housing can be designed in whatever manner as long as it is ensured that the water makes intensive contact with the salt body contained therein, and that no additional undesirable substances are introduced to the water as a result of the housing material. Such a salination unit is associated with an advantage in that to the greatest possible extent it achieves maintenance-free operation, apart from exchange after consumption, as a result of the use of exclusively passive components.

In one embodiment of the present disclosure the salination unit comprises several separate salination devices, spaced apart from each other, which can individually be subjected to condensate whose salt content is to be increased. This makes it possible to implement improved reliability of operation of a salination unit, because in the case of failure of one of several salination devices it need not be assumed that the performance of all the salination devices of an individual salination unit is impeded. Furthermore, with this embodiment the various salts can be accommodated in separate salination devices, and thus undesirable interactions between the individual materials during production, storage and usage are avoided.

In one exemplary embodiment the separate salination devices are interconnected by a parallel connection. Individual valves make it possible to individually control the volume flow through the respective salination device, so that during a malfunction, consumption of the available salt or the like, any affected salination device is closed off from the inflow of the condensate, and another salination device for salination of the condensate is opened. With the use of salt bodies in housings, by successive consumption of several salt bodies in separate salination devices, parallel connection makes it possible to extend the maintenance interval relating to the exchanging or re-filling of unspent salt bodies. In order to prevent any undesirable reactions among various salts, the individual salination devices can also comprise different salts that flow in at different volume flows, which can be controlled by the valves.

In one exemplary embodiment the separate salination devices are interconnected in the form of a series connection. This provides a particular advantage in that with a relatively small volume flow of a condensate whose salt content is to be increased, comparatively fast or intensive salination is made possible.

It is understood that it is also possible for several salination units comprising separate salination devices to be individually interconnected in a series connection or parallel connection. Consequently, the individual advantages of the different linking forms can be combined. Parallel connection of several salination units that comprise salination devices that are interconnected in series may be advantageous.

In another exemplary embodiment of the present disclosure the arrangement comprises at least one intermediate reservoir arranged upstream of the salination unit. A continuous volume flow may be advantageous to ensure effective control of the salt concentration and dissolution, which is as uniform as possible, of a salt body with a flow around it or through it. Since water production from the fuel cell cannot be influenced, the intermediate reservoir is provided as a buffer. In one of various embodiments, a fill level sensor is provided that measures the fill level of the intermediate reservoir and transmits it to the control unit. When a maximum value relating to the fill level of the intermediate reservoir is achieved, the water is conveyed through the salination unit by means of a valve that opens. If the value drops to below a minimum value, the flow into the salination unit is interrupted again by the closure of this valve. This results in intermittent operation.

In one exemplary embodiment of the present disclosure the salination unit comprises a storage tank and a metering device, wherein the metering device is designed to dispense a metered quantity of a saline substance from the storage tank to a reservoir containing water. This type of salination is referred to as discontinuous salination in which a discrete quantity of a saline substance is dispensed to a reservoir containing water in order to increase the salt concentration. The saline substance can comprise various characteristics and can be present in a solid, a powdery or a crystalline form, and as an alternative also in liquid form as a solution.

In one of various embodiments, the above-mentioned water-comprising reservoir is designed as a supply reservoir that is used to supply water to a water system, thus serving as a or the primary reservoir. Accordingly, in this particular case the salination unit is designed to fill a discrete quantity of a saline substance directly into a fresh water tank of the fresh water system, for example of an aircraft, and to provide a quality of water that is suitable for human consumption.

In one embodiment of the present disclosure the water-comprising reservoir is an intermediate reservoir that is generally arranged upstream of a supply reservoir and that can be connected to said supply reservoir. The intermediate reservoir can thus, if required, be connected to the supply reservoir in order to dispense to the supply reservoir a quantity of condensate whose salt content has been fully increased. The supply reservoir is thus exclusively filled with water whose salt content has been fully increased. In this arrangement the intermediate reservoir forms a buffer reservoir that is continuously filled by condensate from the fuel cell so that, if a particular fill level is detected, the salination unit carries out discontinuous salination, after which the water whose salt content has been increased is fed from the intermediate reservoir to the supply reservoir.

In another exemplary embodiment the control unit is connected by means of a valve between the intermediate reservoir and the supply reservoir and is designed to determine when the salt content of the water contained in the intermediate reservoir is fully increased after the addition of the metered quantity of a saline substance. By taking into account an average dissolution time with the use of a solid saline substance it can be ensured that during removal of the water, whose salt content has been increased, from the intermediate reservoir no salt residue remains in the intermediate reservoir and that the supply reservoir always comprises the prescribed salt concentration.

In one embodiment the storage tank comprises a saline solution that is generally highly concentrated and largely saturated so that, by means of adding this saline solution, salination can be provided relatively quickly without observing a dissolution time or the like.

In another embodiment of the present disclosure the storage tank contains water-soluble tablets comprising a saline substance, wherein by means of the metering device, for example, a predetermined number of salt tablets are placed in the reservoir. In this arrangement the metering device can be a rotary slide, or, in the case of stacked tablets being used, the lowermost tablet can be added to the water at any given time with the use of a slide gate.

In one exemplary embodiment of the present disclosure the water-comprising reservoir, which can be the supply reservoir or the intermediate reservoir, comprises a fill level sensor that can be connected to the control unit, wherein the control unit is designed, depending on the water quality and the fill quantity in the reservoir, to determine a quantity of the saline substance that is to be placed in the reservoir in order to achieve a predetermined quality of drinking water, and to control the metering device so that it delivers the determined quantity. In this manner, depending on the existing salt concentration in the reservoir, a necessary quantity of salt can automatically be determined, which quantity is necessary to achieve the required salt content and the required pH-value, in order to take this into account in a subsequent continuous or discontinuous method. In this arrangement a largely constant quality of drinking water in the reservoir can be achieved without this necessitating manual intervention.

According to various embodiments, a method is provided. In one example, the method comprises the characteristics of generating water by means of a fuel cell process and subsequent condensation, by means of measuring a water quality of water, by means of salination by adding an basic salt to the water, and by means of acquiring an operating state of the salination unit.

In order to set a desired quality of drinking water, a control unit controls the salination unit depending on the determined water quality and on the determined operating state.

As described above, in one embodiment salination can comprise a flow through a salination unit with a salt body enclosed by a housing; alternatively or in addition to this also the delivery of a saline substance by means of a metering device.

In one exemplary embodiment several separate salination units are used, wherein depending on the operating state of the individual salination devices, the control unit opens or closes individual stop valves to the salination devices.

The arrangement according to the present disclosure and the method according to the present disclosure are particularly suitable for generating and treating water on board an aircraft in which with the use of a fuel cell the weight of water to be carried along can be saved. Nonetheless, the arrangement according to the various teachings of the present disclosure and the method according to the various teachings of the present disclosure ensure that automatically setting a quality of drinking water can be achieved, even in the case of variable production of water by the fuel cell.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a diagrammatic block-based view of a first exemplary embodiment of the arrangement according to various embodiments.

FIG. 2 shows a second exemplary embodiment with two salination units in a parallel connection.

FIG. 3 shows a further exemplary embodiment with two salination units in a series connection.

FIG. 4 shows a further exemplary embodiment with a recirculation line.

FIG. 5 shows a further exemplary embodiment with a recirculation line and two salination units in a parallel connection.

FIG. 6 shows a further exemplary embodiment with a recirculation line and two salination units in a series connection.

FIG. 7 shows the pH-value curve when implementing a method according to various embodiments.

FIG. 8 shows an exemplary embodiment with a salination unit comprising a metering unit.

FIG. 9 shows a further exemplary embodiment with two salination units comprising a metering unit.

FIG. 10 shows an aircraft, comprising an arrangement according to the various teachings of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

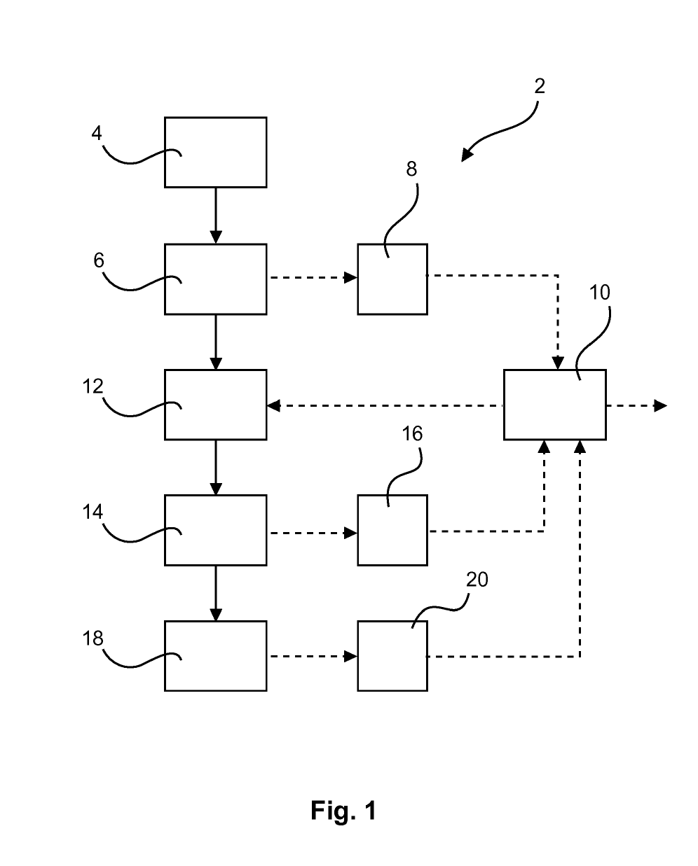

FIG. 1 in a diagrammatic block-based view shows an arrangement 2 according to various embodiments for generating and treating water. To this effect a fuel cell 4 is provided that comprises a water-generating system (not shown in detail). The water generated therein is, for example, fed in a gravity-driven manner to an intermediate reservoir 6 shown as an example, which intermediate reservoir 6 comprises a fill level sensor 8 that is designed to measure the present fill level of the intermediate reservoir 6. The measured fill level is transmitted in the form of a signal to a control unit 10.

Conveying equipment 12, which is also connected to the control unit 10, conveys water from the intermediate reservoir 6 to a salination unit 14 that is designed to enrich water, which enters or flows through a salination device, with salt ions. An operating state of the salination unit 14 is acquired by way of a state measuring device 16 that transmits a corresponding signal to the control unit 10. The water, whose salt content has been increased, which water flows from the salination unit 14, is fed to a supply reservoir 18 that is connected to a water-quality measuring device 20.

In one example, the water-quality measuring device is designed for determining the conductivity of water. From the interrelation between influencing the salt content and the pH-value of the basic salt or salt mixture used, it is possible from the conductivity of the water in the supply reservoir 18 to deduce the arising pH-value. A corresponding signal is transmitted to the control unit 10. As an alternative to this the water-quality measuring device 20 can determine the pH-value of the water in the supply reservoir 18 directly, a process which when applied in a means of transport may be difficult because of the temperatures, vibrations and motion forces.

In the exemplary embodiment shown, the salination unit 14 may be designed in such a manner that a salt body is arranged in a housing that comprises an inlet and an outlet. Water that flows through the inlet into the housing and that flows out from it again through the outlet flows through or around the salt body, which subsequently dispenses salt ions to the water. In this arrangement the concentration of the salt in the water depends on the volume flow moving through the salination unit 14. The volume flow can thus represent a controlled variable for the control unit 10.

The progress of consumption of the salt body, which is, for example, a cylindrical or bar-shaped body whose external diameter is reduced during continuous flow around it, is a further physical parameter that contributes to determining the resulting salinity. As a result of the reduction in the diameter, the surface of the salt body that dispenses salt ions thus becomes smaller, and consequently, with a constant volume flow per unit of time, consistently fewer salt ions are dispensed. The state measuring device 16 is designed, depending on the respective design of the salination unit 14, to determine a parameter that characterizes the ability to dispense salt ions. In the case shown, this parameter may be determined in part by the diameter or the size of the outer surface around which water can flow.

To ensure that even under changing operating conditions of the fuel cell 4 a constant salt concentration in the supply reservoir 18 can be maintained, control of the salination process is necessary, which takes place by the control unit 10 with the use of said transmitted variables. By knowing the measured variables of conductivity or pH-value and the operating state of the salination unit 14 the control unit 10 is basically able, depending on the respective ability of the salination unit 14 to dispense salt ions to water flowing through, to control the conveying equipment 12 for influencing the salination unit 14 so that water of a constant drinking water quality is filled into the supply reservoir 18.

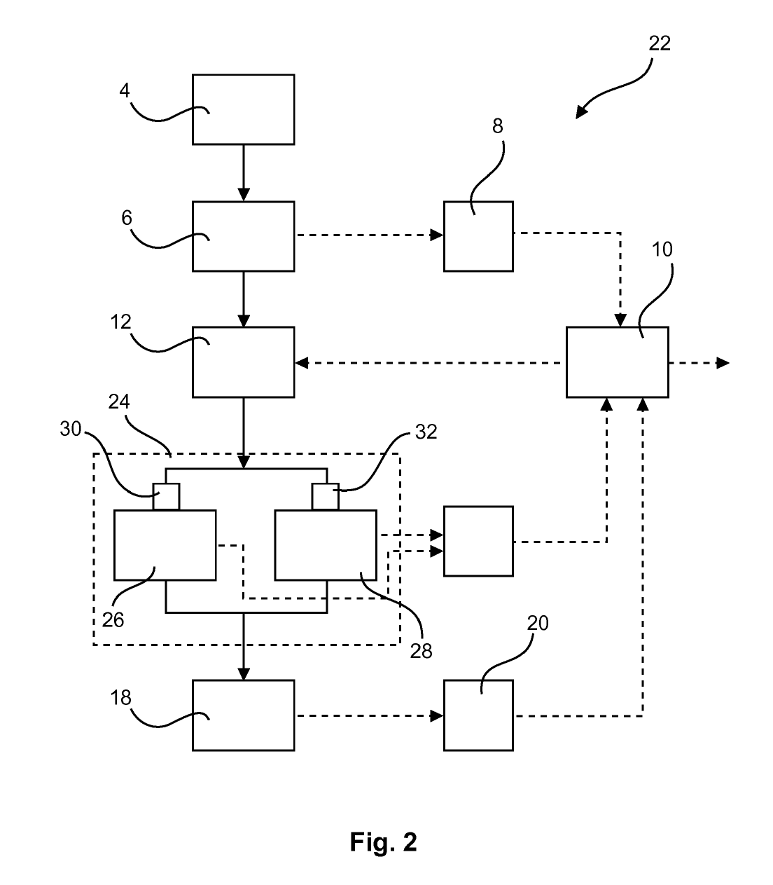

FIG. 2 shows a slight modification in which an arrangement 22 according to the various teachings of the present disclosure comprises a salination unit 24 that comprises two separate salination devices 26 and 28 that form a parallel connection. By arranging valves 30 and 32 whose flow can be influenced, water from the conveying equipment 12 can flow either through the one salination device 26 or through the other salination device 28 or through both salination devices 26 and 28. Accordingly the state measuring device 16 is connected both to the one salination device 26 and to the other salination device 28. Corresponding signals are transmitted to the control unit 10.

In the case of more complex salt compositions, during the production of the salt body or during contact with water in the singular salination unit 14 shown in FIG. 1, undesirable reactions in the salt components may occur, and as a result of this, in the salt body, for example compounds of greatly differing solubility can arise. Under certain circumstances this results in impeding the function of the salination unit 14 so that the desired salt concentration can no longer be attained. In order to prevent this, the arrangement 22 according to the present disclosure can be expanded to the effect that two or more salination devices 26 and 28 are used, which are connected in parallel. Each salination device 26 or 28 then only comprises certain salt components so that undesirable reactions can be prevented.

In order to regulate the volume flow through the salination devices 26 and 28 the valves 30 and 32 are used, which can be controlled by the control unit 10 so that individual mixing proportions of the different salination devices 26 and 28 can be achieved.

As an alternative to this, the two salination devices 26 and 28 can also comprise the same salt bodies, and the valves 32 and 30 are successively opened so that after a salt body of a salination device 26 or 28 has been consumed, the salt body of the next salination device 28 or 26 is consumed. In order to increase the concentration or the salination speed, in this case it is, however, also possible for water to flow through both, or through all, the salination devices 26 and 28 with the valves 30 and 32 fully open. The overall volume flow through the salination unit 24 remains the same, but the individual volume flows 26 and 28 are smaller than the overall volume flow, and consequently the resulting discrete fluid volumes spend more time on salt-ion-dispensing surfaces of a salt body or the like than is achievable with a higher volume flow and thus with higher salt concentration.

With reference to FIG. 2, purely as an example, it is shown that two separate salination devices 26 and 28 are used, but theoretically any number of salination devices connected in parallel can be used.

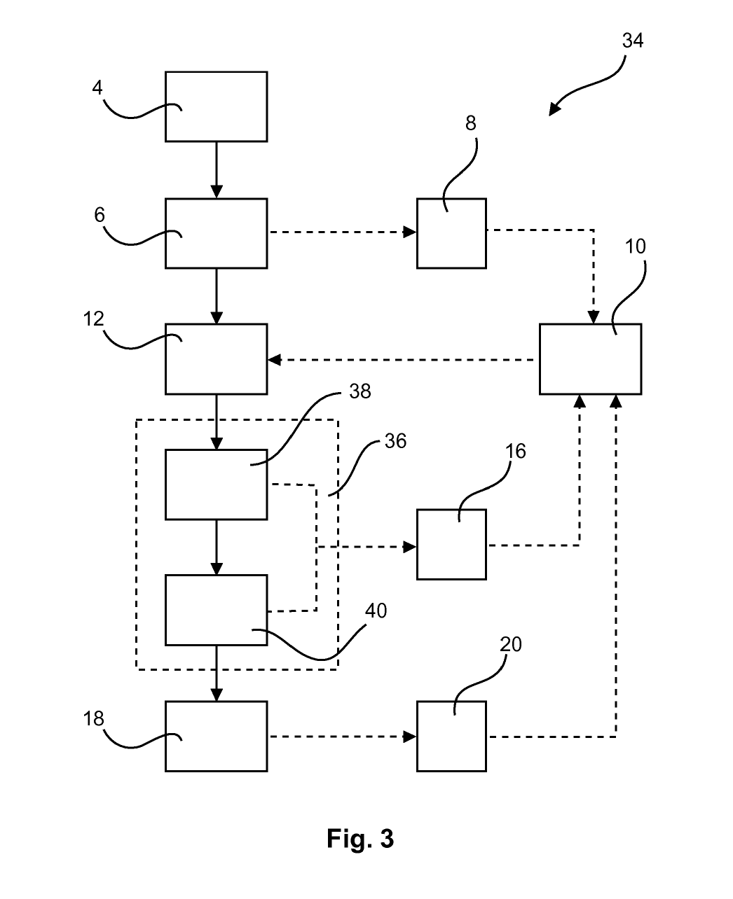

The exemplary embodiment, shown in FIG. 3, of an arrangement 34 according to the various teachings of the present disclosure comprises a salination unit 36 with two separate salination devices 38 and 40 that are interlinked in a series connection. With an unchanging volume flow through both salination devices 38 and 40, through which liquid flows successively, for the most part even dissolution of salt takes place so that overall a relatively high salt concentration can be achieved. The two salination devices 38 and 40 can also comprise different salts or salt mixtures so that, as in the example of FIG. 2, undesirable reactions of the various salts can be ruled out. In this exemplary embodiment, too, both salination devices 38 and 40 are connected to a state measuring device 16 for acquiring an operating state.

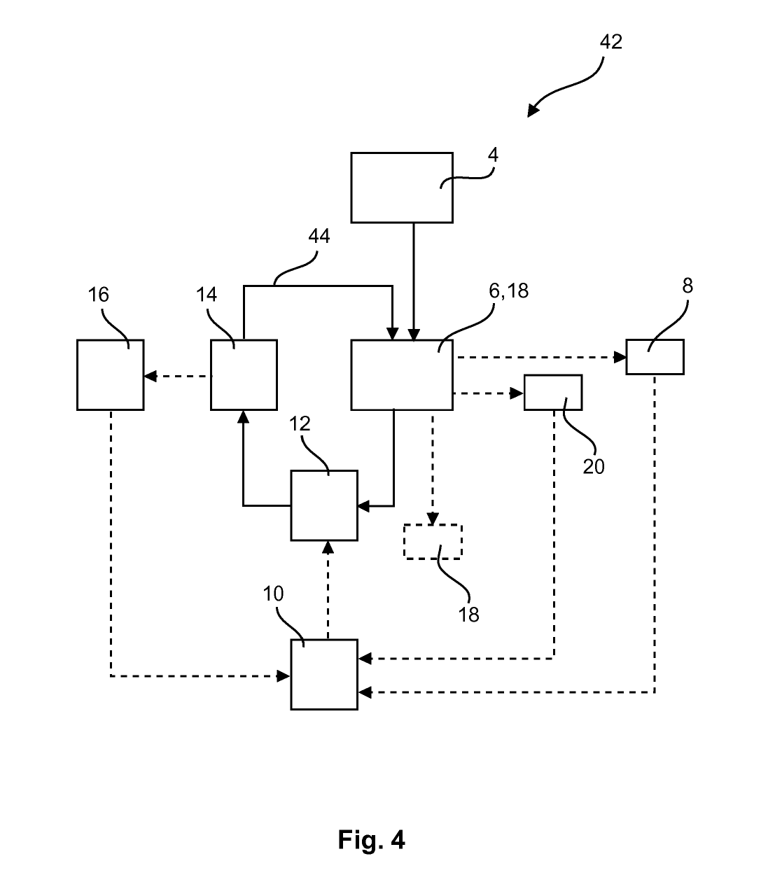

An arrangement 42 according to various embodiments, which arrangement is shown in FIG. 4, comprises a slightly modified design. In the arrangement according to FIG. 1, in which water flows through the salination unit 14 precisely once, setting the desired salt concentration is only possible by means of regulating the volume flow. Since the extent of this flow cannot be selected at will, the solubility speed of the salt body itself should match the volume flow conditions of the overall system as well as possible. As an alternative, the arrangement 42 shown in FIG. 4 can be used. This exemplary embodiment is characterized in that the conveying equipment 12 feeds water from a reservoir containing water, which reservoir can be an intermediate reservoir 6 or the supply reservoir 18, to a salination unit 14, and by means of a recirculation line 44 the water whose salt content has been increased is fed back to the reservoir. By continuously measuring the water quality by means of the water-quality measuring device 20, the control unit 10 can detect when the salt concentration in the water-comprising reservoir is sufficient. If the reservoir is the intermediate reservoir 6, the latter can then be emptied into the supply reservoir 18, which is indicated by the dashed line. If the reservoir is the supply reservoir 18, the latter can directly supply water to consumers of water.

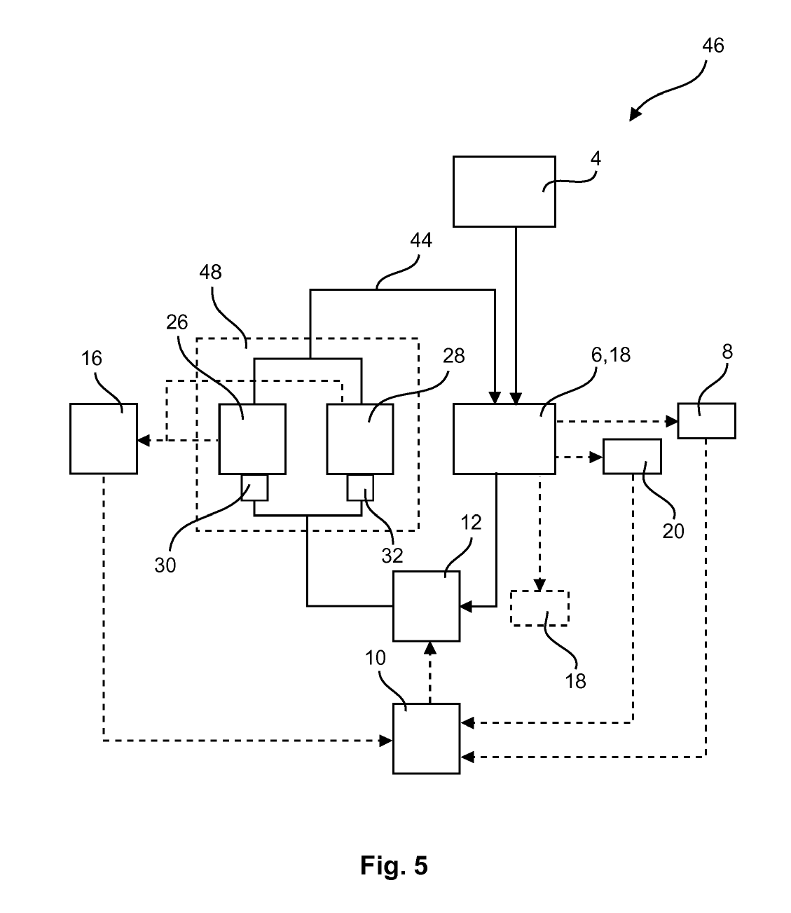

In another exemplary embodiment of an arrangement 46 according to the present disclosure according to FIG. 5 a salination unit 48 comprises two salination devices 26 and 28, connected in parallel, with valves 30 and 32, similar to the arrangement shown in FIG. 2.

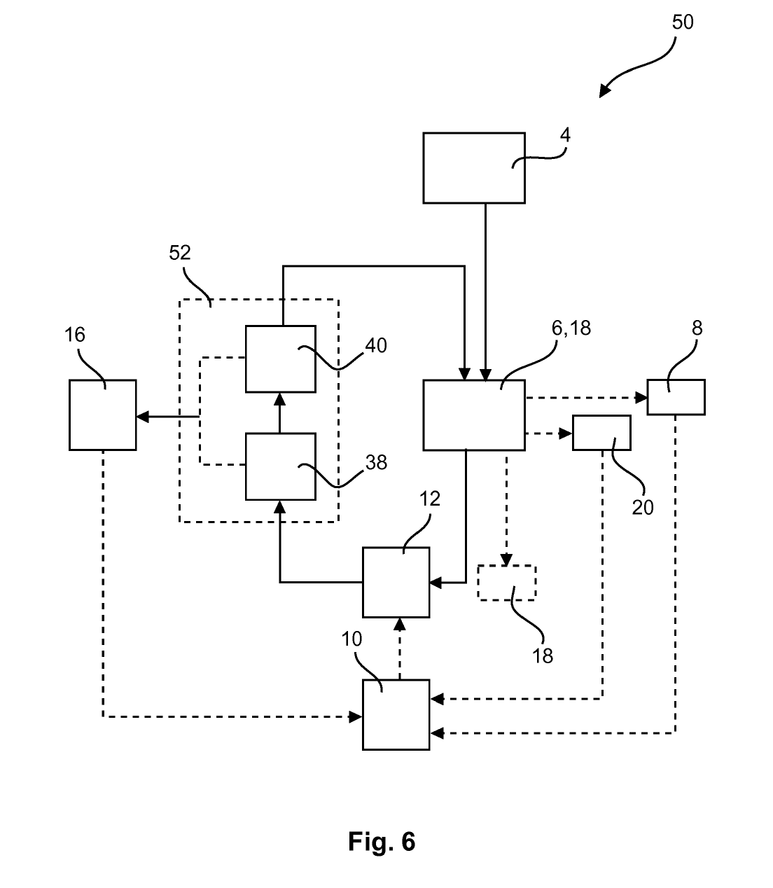

Likewise, FIG. 6 shows a further modification in the form of an arrangement 50 according to various embodiments, in which modification a salination unit 52 comprises two salination devices 38 and 40 in a series connection.

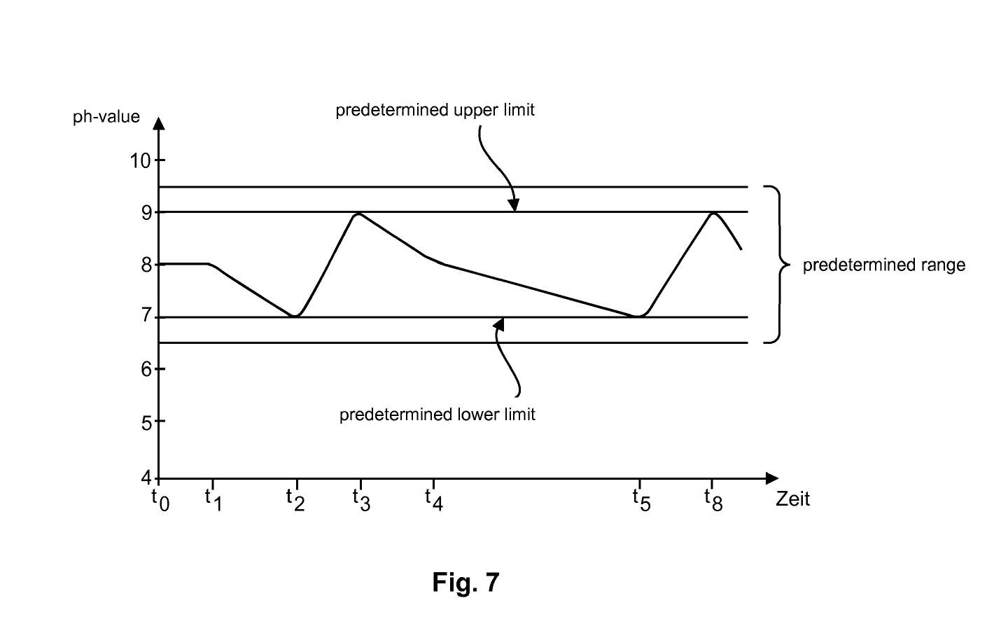

An example of a control principle is shown in FIG. 7. The pH-value curve projected over time is shown. At the point in time tₒ the fuel cell 4 is switched off, and a certain quantity of water is contained in a water-comprising reservoir 6 or 18, which water has a pH-value of, for example, 8. At tᵢ the fuel cell 4 is switched on. De-ionized water is conveyed to the intermediate reservoir 6 or supply reservoir 18. Accordingly, as a result of dilution of the salt concentration, the pH-value drops. After dropping below a predetermined lower limit, at t₂ water is conveyed through a salination unit, and consequently the pH-value rises. At t₃ the predetermined upper limit of the pH-value of, for example, 9 has been reached, and conveying is interrupted. Since the fuel cell 4 continues to produce water, the pH-value drops again. At t₄ the operating conditions of the fuel cell 4 change to the effect that less water is produced, and consequently dilution and thus the drop in the pH-value slow down. At t₅ the lower limit in the form of a pH-value of 7 is reached again, after which salination commences anew as described above.

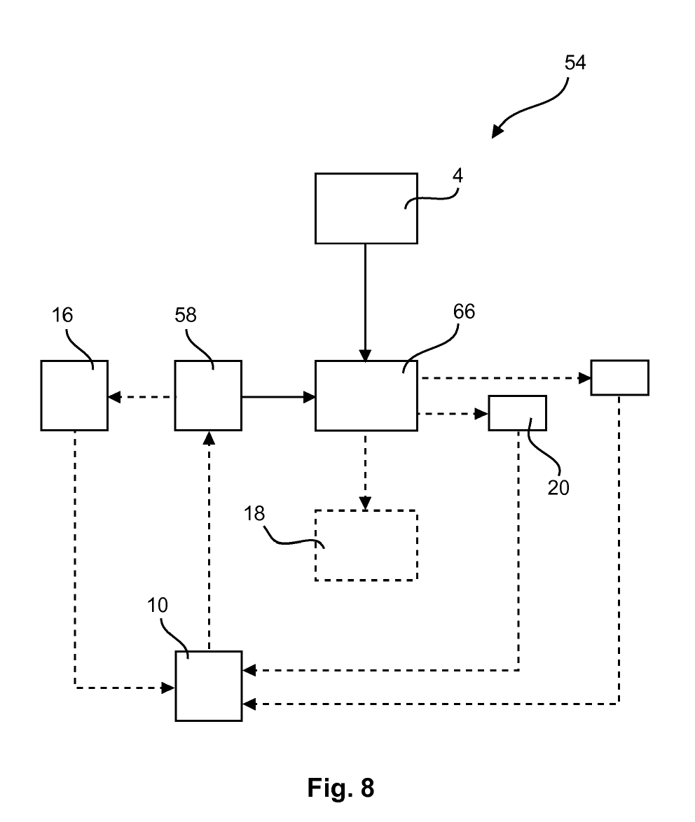

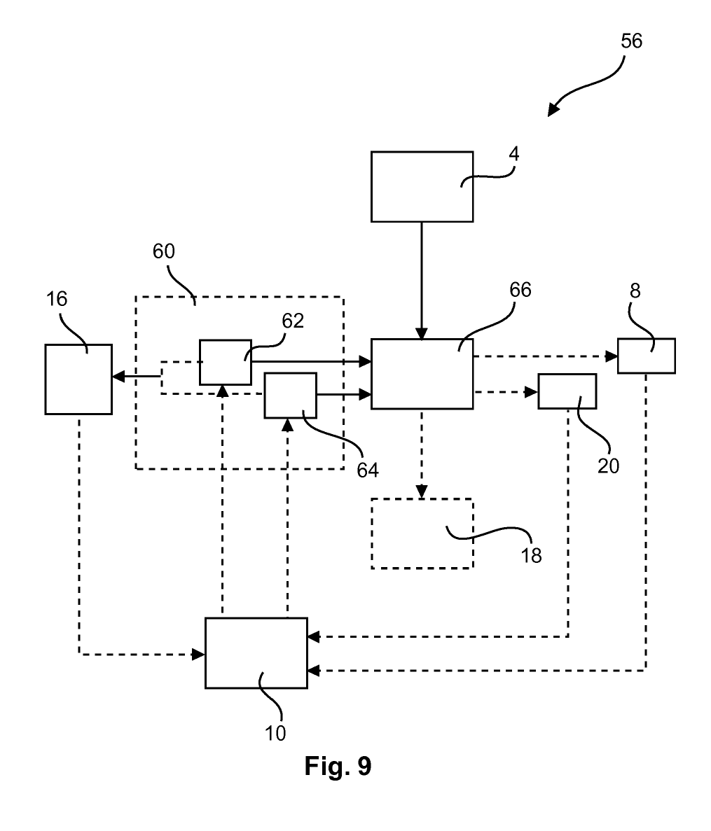

FIGS. 8 and 9 each show an arrangement, 54 and 56, according to various embodiments of the present disclosure, in which arrangement a discontinuous salination unit 58 or 60 is used. In FIG. 9 the salination unit 60 comprises two separate salination devices 62 and 64 in a parallel connection. The arrangements 54 and 56 are characterized by a metering unit (not shown in further detail) that in a discontinuous manner dispenses a discrete quantity of a saline substance from a storage tank to the water in a water-containing reservoir 66 that is designed either as a supply reservoir or as an intermediate reservoir. If the water-containing reservoir 66 is an intermediate reservoir, the water whose salt content has been increased can finally be delivered to a supply reservoir 18.

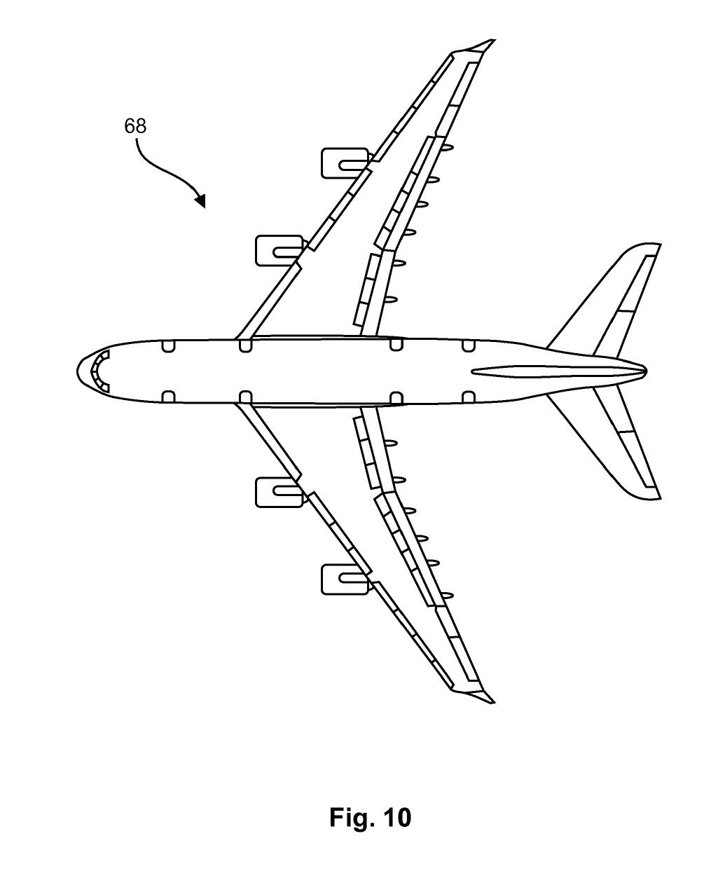

Finally, FIG. 10 shows an aircraft 68 comprising a fuel cell system and providing a drinking water supply with the use of an arrangement according to the various teachings of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. An arrangement for generating and treating water, comprising:
a fuel cell with a water-generating system,
a salination unit for the salination of water with a variable salt concentration, the salination unit designed to add a basic salt to water,
a state measuring device for acquiring an operating state of the salination unit,
a water-receiving reservoir arranged downstream of the salination unit for receiving water whose salt content has been increased,
a water-quality measuring device for measuring the water quality of the water whose salt content has been increased, the water-receiving reservoir connected to the water-quality measuring device, and
a control unit connected to the water-quality measuring device and to the state measuring device, the control unit sets a predetermined water quality in the water-comprising reservoir and controls the salination unit depending on the operating state of the salination unit and on the measured water quality.

2. The arrangement of claim 1, further comprising conveying equipment arranged downstream of the fuel cell that leads water from the fuel cell to the salination unit.

3. The arrangement of claim 1,
wherein the water-quality measuring device is a device for measuring the conductivity of water.

4. The arrangement of claim 1,
wherein the salination unit comprises at least one salt body enclosed by a housing, and the housing comprises an inlet and an outlet so that, due to the flow around or flow through, salt ions from the salt body are dispensed to water flowing in through the inlet and flowing out through the outlet.

5. The arrangement of claim 1,
wherein the salination unit comprises several separate salination devices.

6. The arrangement of claim 5,
wherein the separate salination devices are arranged in a parallel connection, and individual valves control the volume flow through the respective salination device.

7. The arrangement of claim 5, wherein the separate salination devices are interconnected in a series connection.

8. The arrangement of claim 1, further comprising at least one intermediate reservoir arranged upstream of the salination unit.

9. The arrangement of claim 1,
wherein the salination unit comprises a storage tank and a metering device, wherein the metering device dispenses a metered quantity of a saline substance from the storage tank to a reservoir containing water.

10. The arrangement of claim 9, wherein the water-receiving reservoir is a supply reservoir.

11. The arrangement of claim 9, wherein the water-receiving reservoir is an intermediate reservoir that is connected to a supply reservoir.

12. The arrangement of claim 1, wherein the storage tank comprises a saline solution.

13. The arrangement of claim 1, wherein the storage tank contains water-soluble salt tablets.

14. The arrangement of claim 9,
wherein the water-comprising reservoir comprises a fill level sensor that is connected to the control unit, and the control unit determines, based on the water quality and the fill quantity in the water-comprising reservoir, a quantity of saline substance that is to be placed in the water-comprising reservoir in order to achieve a predetermined quality of drinking water and controls the metering device so that it delivers the determined quantity.

15. A method for treating water generated by a fuel cell, comprising:
generating water by means of a fuel cell process and subsequent condensation,
measuring the water quality in a water-receiving reservoir,
performing salination of the water by adding a basic salt,
acquiring an operating state of the salination unit by means of a state measuring device, and
setting a desired quality of drinking water by way of a control unit by controlling the salination unit based on the determined operating state and the determined water quality.

16. An aircraft, comprising:
a fuel cell with a water-generating system,
a salination unit for the salination of water with a variable salt concentration that adds a basic salt to water,
a state measuring device that acquires an operating state of the salination unit,
a water-receiving reservoir arranged downstream of the salination unit that receives water whose salt content has been increased,
a water-quality measuring device that measures the water quality of the water whose salt content has been increased, the water-receiving reservoir connected to the water-quality measuring device, and
a control unit connected to the water-quality measuring device and to the state measuring device, that sets a predetermined water quality in the water-comprising reservoir and controls the salination unit depending on the operating state of the salination unit and on the measured water quality,
wherein the salination unit comprises several separate salination devices.

17. The aircraft of claim 16, wherein the separate salination devices are arranged in a parallel connection, and individual valves control the volume flow through the respective salination device.

18. The aircraft of claim 16, wherein the separate salination devices are interconnected in a series connection.

19. The aircraft of claim 16, further comprising at least one intermediate reservoir arranged upstream of the salination unit.

20. The aircraft of claim 16, further comprising conveying equipment arranged downstream of the fuel cell that leads water from the fuel cell to the salination unit.
